(19) United States
(12) Patent Application Publication
(10) Pub. No.: US 2003/0058275 A1
(43) Pub. Date: Mar. 27, 2003

(54) Display and manipulation of pictorial images

(76) Inventors: Maurizio Pilu, Bristol (GB); Stephen Bernard Pollard, Gloucestershire (GB); David Mark Frohlich, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/224,569

(22) Filed: Aug. 21, 2002

(30) Foreign Application Priority Data
Sep. 27, 2001 (GB) 0123321.2

(51) Int. Cl. G09G 5/00

(52) U.S. Cl. 345/751

(57) ABSTRACT

There is disclosed a computer apparatus for causing display and manipulation of a pictorial image synchronously with remote computer apparatus. The apparatus comprises computer instructions executable by the apparatus to generate, on a display screen, a graphical user interface (GUI). The GUI has: a) an image display region; b) at least one manipulation control element, activatable by a user input device, for manipulating a displayed image; and c) at least one symbol associated with at least one stored image file. The symbol is activatable by a user input device so as to cause (i) display of a corresponding image in the image display region and (ii) output of a display signal. The display signal is adapted to cause remotely executing computer instructions to process a remotely stored associated image file so as to display a corresponding image.

### FIELD OF THE INVENTION

The invention relates generally to the field of sharing images. More particularly, but not exclusively, the invention relates to a computer apparatus fox causing display and manipulation of a pictorial image synchronously with remote computer apparatus and to a method for enabling synchronous sharing and manipulation of pictorial images by a plurality of computer programs.

### BACKGROUND OF THE INVENTION

U.S. Pat. No. 5,740,161 discloses a method and apparatus for synchronising viewed information in a conferencing environment. A view synchronisation message is sent between endpoints, the message including a page identifier corresponding to an identified location and a centrepoint which identifies a point within the page corresponding to the page identifier. The document is concerned with multiple user data and video conferencing using multiple applications, and with enabling multiple endpoints to display the same location of viewed information. Specifically, U.S. Pat. No. 5,740,161 does not disclose a user-friendly means for facilitating selection, transfer and synchronous manipulation of picture images.

U.S. Pat. No. 5,874,960 discloses a method of sharing documents. A host and a shadow computer system are provided. An application program generating a word processing document is shared, and input to the shared application program can be controlled alternately by the host or the shadow system

One problem with this method is that data relating both to the changed application program and also to the changed document must be communicated between host and shadow each time a document is manipulated. This implies a large bandwidth and/or communication time requirement. A further problem is that control of the program is must be negotiated to establish which user presently has control. This limits freedom of interaction between users and the shared document. A still further problem is that host application and system settings may differ from those of the shadow, resulting in potential inconsistencies in displaying the document. For example, the host and shadow may have different resolutions or colour settings. A further example of application sharing is disclosed in U.S. Pat. No. 5,758,110.

### SUMMARY OF THE INVENTION

In accordance with the invention, there is provided computer apparatus for causing display and manipulation of a pictorial image synchronously with remote computer apparatus. The apparatus comprises computer instructions executable by the apparatus to generate, on a display screen, a graphical user interface (GUI). The GUI has;

a) an image display region;

b) at least one manipulation control element, activatable by a user input device, for manipulating a displayed image; and

c) at least one symbol associated with at least one stored image file.

The symbol is activatable by a user input device so as to cause (i) display of a corresponding image in the image display region and (ii) output of a display signal. The display signal is adapted to cause remotely executing computer instructions to process a remotely stored associated image file so as to display a corresponding image.

In accordance with a still further aspect of the invention, there is provided a method for synchronous sharing and manipulation of digital images by respective users having respective computer apparatuses, comprising:

a) causing each respective apparatus to display a graphical user interface comprising (i) at least one symbol activatable for selecting an associated digital image for display and/or transfer and (ii) at least one manipulation control element activatable fox manipulating a displayed digital image; and

b) activating a said symbol so as to thereby (i) cause a digital image to be displayed locally and also (ii) when a remote user's computer apparatus has received a copy image file corresponding to the locally displayed digital image, cause a corresponding digital image to be displayed using a remote user's computer apparatus.

In accordance with a still further aspect of the invention, there is provided a method for synchronous collaborative viewing of a collection of photographic pictures, comprising:

a) running a first applications program to cause a plurality of symbols to be displayed corresponding to a plurality of stored picture files;

b) in response to receipt of a control signal, initiating transfer of selected said picture files to enable processing thereof by a second applications program of similar type to said first applications program; and

c) causing to be displayed a visual indication for distinguishing symbols corresponding to transmitted picture files.

In accordance with a further aspect of the invention, there is provided computer apparatus comprising computer instructions executable by the apparatus to generate, on a display screen, a graphical user interface having:

a) an image display region for displaying an image;

b) at least one symbol activatable by a user input device for selecting at least one respective associated image file;

c) an output control element activatable by a user input device to cause the apparatus to output at least one selected image file for processing by the remotely executing computer instructions; and

d) a symbol transfer control element activatable by a user input device to cause the apparatus to output a compressed and low resolution version of at least one selected image file for enabling substantially similar, remotely executing, computer instructions to cause at least one corresponding symbol to be displayed.

In accordance with a farther aspect of the invention, there is provided computer apparatus for causing display and manipulation of a pictorial image synchronously with remote computer apparatus, comprising computer instructions executable by the apparatus to generate, on a display screen, a graphical user interface having:

a) an image display region for displaying an image;

b) at least one symbol activatable by a user input device for selecting at least one respective associated image file; and

c) at least one manipulation control element activatable by a user input device to:

i) generate at least one manipulation control signal for manipulating an image displayed in the display region; and

i) cause the apparatus to output a corresponding manipulation control signal adapted to cause synchronous processing by substantially similar, remotely executing, computer instructions.

The invention also extends to computer programs in the form of computer readable instructions, particularly on or in a carrier, for putting the invention into practice.

The invention facilitates greater dynamic interaction and enjoyment between users synchronously sharing and manipulating images, in that intuitive control of image manipulation and/or transfer with minimum user input device activity and low response time is facilitated.

### DETAILED DESCRIPTION

In order that the invention may be well understood, an embodiment thereof will now be described, by way of example only, with reference to the accompanying drawings, in which:

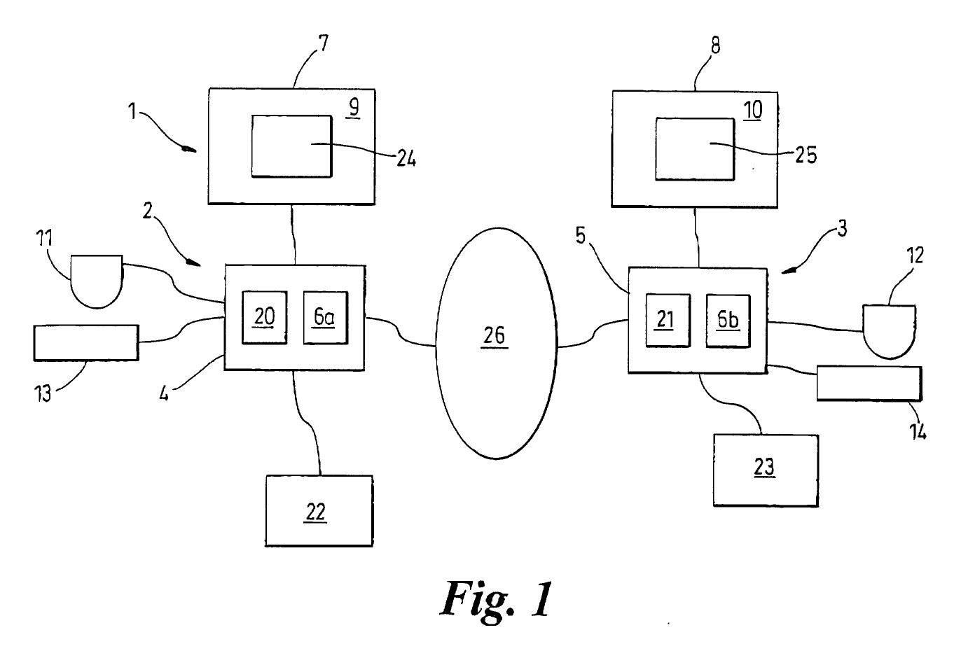

FIG. 1 is a schematic diagram showing a photo-conferencing system operable to enable an image-sharing event including synchronous display and manipulation of digitally stored photographic images by a plurality of computer apparatuses;

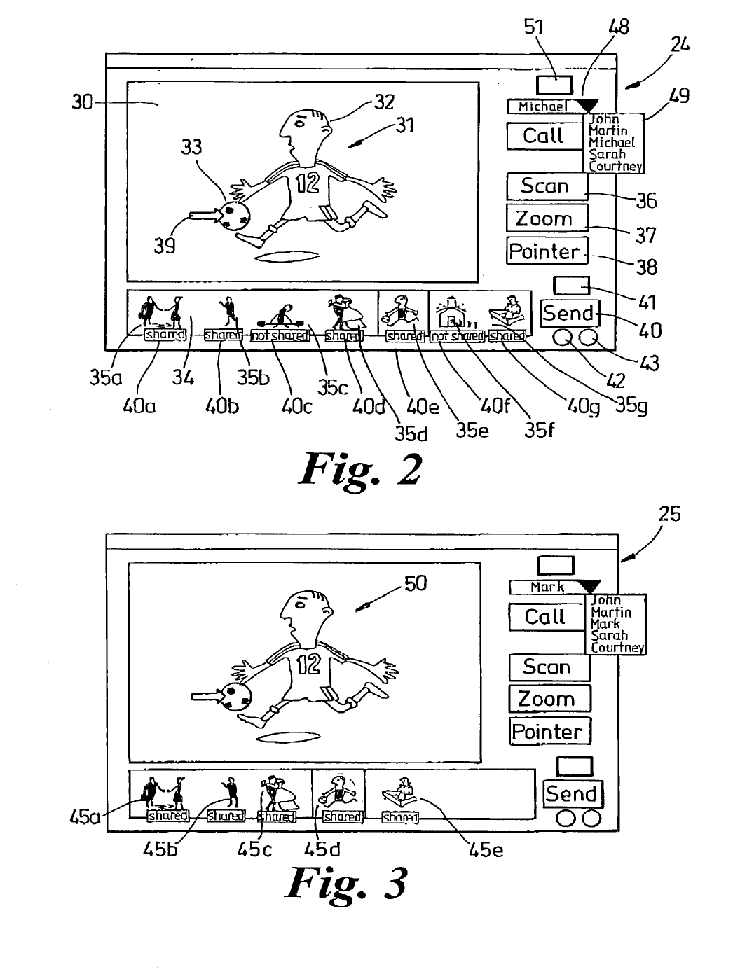

FIG. 2 shows a graphical user interface (GUI) generated using a first application program of the system; and

FIG. 3 shows a GUI generated using a second application program of the system, executing remotely of the first application program.

The photo-conferencing system 1 shown in FIG. 1 comprises first and second computer systems 2, 3. Each computer system 2, 3 respectively includes computer apparatus 4, 5, for electronically processing stored pictorial image data files 6a, 6b. Each computer system 2, 3 fiber includes a respective display device 7, 8, for example a cathode ray tube or flat screen display terminal, having a display screen 9, 10. The computers 4, 5 take the form of personal computers, but may alternatively be any other form of device capable of electronically processing data Such an alternative device might be a dedicated picture-sharing device, and might include a display device as an integral feature thereof.

Each computer system 2, 3 also includes a user input device in the form of a pointing device such as a mouse 11, 12 for guiding a cursor on the display screen 9, 10, and a further user input device in the form of a keyboard 13, 14. Clearly, other suitable forms of pointing device 11, 12 will be apparent to the skilled reader, and it should be understood that the keyboard 13, 14 can also act as a pointing device. Other suitable forms of user input device will be apparent to the skilled reader, for example a vocal user input system or other human computer interaction (HCI) method.

Computer instructions in the form of an applications program 20 are loaded in memory in the computer 4 for execution by a processor of the computer 4, and a similar applications program 21 is similarly loaded in memory in the other computer 5. A respective data input device 22, 23 is connectable to each computer 4, 5 for loading a respective set of image data files 6a, 6b into memory in each computer 4, 5. The respective sets of image data files 6a, 6b conveniently constitute albums of pictorial images, for example photographic images which have been digitally or otherwise captured. The input devices 22, 23 could, for example, be a scanner, a digital camera, a data storage device for example including a CD ROM, or any other device for capturing and/or storing digital data. Alternatively, the image data files may be input from a remote source such as another computer, for example over the internet.

A user can instruct the computer 4 to execute the applications program 20 using the keyboard 13 and/or mouse 11. The executing program 20 causes a graphical user interface (GUI) 24 to be displayed on the display screen 9. In order for mutually remote first and second users to interactively transfer and manipulate images, the computers 4 and 5 must be interconnected for communication with one another across a communications network 26, for example using Internet Protocol (IP) or another communications protocol, and the computer 5 roust be executing the other applications program 21 so as to generate a GUT 25 for display on the display screen 10. The communications network 26 may include the internet, for example, and/or a private or public telephone network The network 26 may be adapted to facilitate peer to peer communication.

A voice-over-IP or other digital voice transmission system is provided as part of the computer systems 2 and 3, or separately for use with the systems 2 and 3. The technology for achieving this will be apparent to the skilled reader, and is therefore not described in detail herein.

The programs 20 and 21 are adapted for causing the computer apparatuses 4 and 5 to respectively transfer control signals and data between one another in the form of digital and/or analogue signals. Data may, for example, to be output (“pushed”) by local computer 4 for receipt by the or each remote computer 5. Also, the program 20 executing on computer 4 may cause the computer 4 to output control signals adapted to cause remote computer 5 to output selected data for receipt by the local computer 4 (that is, to “pull” data from the remote computer 5). Whilst the programs 20, 21 and computers 4,5 are substantially identical, it should be understood that this is not essential and that in practice many inconsequential differences are likely.

A variety of arrangements will be apparent to the skilled reader by which the computers 4 and 5 can respectively store and execute the programs 20 and 21 to cause the computer systems 2 and 3 to display the GUIs 24 and 25, and by which the computers 4 and 5 can store and process the image data files 6a and 6b under control of the programs 20 and 21. For examples U.S. Pat. No. 5,740,161, incorporated herein by reference, describes a suitable computer system hardware arrangement with reference to FIG. 3 of that document.

The communications network 26 can include any communications medium suitable for carrying the program control signals and image data in any convenient form, for example an integrated services digital network (ISDN) line, plain old telephone service (POTS) line, fibre optic or ethernet line or wireless link.

FIG. 2 shows a view of the GUI 24 available to a local user A. The GUI 24 has an image display region 30 in which is displayed an image 31 featuring a soccer player 32 and ball 33, and a thumbnail display region 34 in which is displayed a set of thumbnails 35a-g.

FIG. 3 shows a view of the GUI 25 available to a remote user B. GUI 25 has similar features to GUI 24, except that a set of thumbnails 45a-e displayed in GUI 25 for viewing by user B is different to the set of thumbnails displayed in GUI 24. To avoid unnecessary repetition, GUI 24 will be described in detail hereinafter, whereas features of GUI 25 which are identical to those of GUI 24 will not be described in detail.

The thumbnails 35a-g are low resolution miniature representations, for example generated by the program 20 using the image data files 6a. The thumbnails 35a-g facilitate easy recognition of images by the user A. Each thumbnail 35a-g assists the user A to determine whether s/he wishes an image corresponding to a thumbnail 35a-g to be displayed in the image display region 30 and/or shared with a user B of the remotely executing program 21. A desired image is selectable by activating a corresponding thumbnail 35a-g using the mouse 11 or keyboard 13.

It will be appreciated that, whilst thumbnails are a particularly effective means of representing images, other forms of activatable symbol could be used instead of thumbnails. Non-exhaustive examples of alternative activatable symbols include: iconic representations not directly generated from the image data files, such as user-inserted titles or miniature images selected by the user; file names; or any other such representations or combinations thereof that enable a user to associate the symbol with an image stored in an image data file.

A thumbnail 35e corresponding to the presently displayed image is caused to be visually distinguished from the other thumbnails. For example the colour or appearance of the background may be varied. However, a variety of alternative distinguishing techniques will be apparent to the skilled reader. Also, the thumbnails 35a-g are associated with respective visual indicators to indicate whether their associated image data files are accessible by the remote program 21. For example, labels 40a-g are respectively associated with the thumbnails 35a-g, containing words indicative of whether their corresponding image data files are shared or not shared with the remote program 21.

The GUI 24 also includes manipulation control elements in the form of icons 36, 37, 38 respectively labelled scan, zoom and pointer. The icons are activatable by the mouse 11 to cause the program 20 to generate manipulation control signals to cause the image data file for the displayed image to be processed to cause appropriate manipulation of the displayed image 31.

When the scan icon 36 is activated, for example, the mouse 11 or keyboard 13 can be used to move the image in a desired direction, for revealing image features not presently displayed and/or selecting a desired screen print. Similarly, the zoom icon 37 enables a user to zoom in and out of aspects of the image 32 chosen for example, using a cursor (not shown). Activation of the pointer icon 38 causes a pointer 39 controllable by the mouse 11 and/or keyboard 13 to appear in the display region 30, for drawing attention to a desired feature of the image 32. Clearly, other manipulation functions will be apparent to the skilled reader for enabling a user to interact with an image using the GUI 24.

The GUI 24 also has an output control element in the form of a send icon 40 activatable by the mouse 11 or keyboard 13 to cause the computer 4 to output for processing by the remote program 21 at least one selected image file 6a. The image file or files can be selected using the thumbnails 35a-g and a pointing device 11, 13, and means may also be provided for selecting all “not shared” image files for batch transfer. The remote program 21, like the program 20, is adapted to store for local processing the or each image file sent by the other program 20, 21.

Use of the send icon 40 is not necessary to send a single image file. In one operating mode, when a “not shared” thumbnail is appropriately activated by the mouse 11 or keyboard 13, for example by double clicking the thumbnail, the program 20 causes the computer 4 to (i) cause a corresponding image to be displayed in the local image display region 9 and (ii) cause a corresponding image file to be transmitted to the remote computer 5 for remote storage and processing of the image file and automatic remote display of a corresponding image in the remote image display region 10. Thus, each thumbnail 35a-g acts as an output control element to provide a convenient alternative user interface command for single image file transfers.

In this mode, when a single image file 35e is selected and transmitted by the program 20, the receiving program 21 automatically causes a viewable image 31 corresponding to the received file to be generated and displayed in its display region 10. In an alternative mode, the receiving program 21 is not arranged to automatically display single received images, and the program 20 causes the computer 4 to output with the image data file a display signal adapted to cause the remotely executing program 21 to process and store a copy image file and synchronously display a corresponding image.

Where a single “shared” thumbnail 35a,b,d,e,f is appropriately activated, for example by double clicking with the mouse 11, the program 20 causes the computer 4 to cause a corresponding image to be displayed in the local display region 9, and to output a display signal adapted to cause the remotely executing program 21 to process its corresponding remotely stored copy image file and synchronously remotely display a corresponding image.

The program 20 is operable to determine whether an image file is shared. This determination may be carried out by searching the memory of the computer 4 to ascertain whether a particular file has previously been transferred to the remotely executing program 21 and, if it has, assuming that the image file is available to the program 21 and is thus “shared”. Alternatively or additionally, the program 20 may cause the computer 4 to search the memory of computer 5 to ascertain whether an image file is already stored there, for example by searching for the file name, by comparing data signatures or by comparing content of the respective stored image files. The latter feature is particularly advantageous in that it enables identification of files which have been shared by virtue of other means of transmission, for example using e-mail, downloading from a website, or by a local input device using a compact disc or other data storage means.

If it is determined that an image file is shared, the program 20 causes the generation of the labels 40a-g to indicate adjacent each thumbnail 35a-g whether its corresponding image is shared or not shared with the remote program 21. Clearly, there are many other ways of visually associating with the thumbnails information regarding whether an image file is shared.

Also, a thumbnail transfer control element may be provided in the form of an icon 41 activatable by the mouse 11 or keyboard 13 to cause the program 20 to generate and output a compressed and low resolution version of at least one image file, singly, in a selected batch or in a global batch containing thumbnail files corresponding to all unshared images. The remote program 2l is adapted to cause a received thumbnail or batch of thumbnails to be displayed in GUI 25. A user 13 of the remote program 21 can then select the or each thumbnail to cause the program 21 to “pull” the or each corresponding image file from the computer 4. Thus, selection of the or each thumbnail causes the computer 5 to output a return signal receivable by the program 20 for causing the computer 4 to output the or each corresponding full image file.

Thumbnails 45a-e may also be transferred by other means, for example by e-mail or CD, to the remote computer 5, without the full image file. Each such thumbnail which is indicated as shared is activatable by the pointing device to send a pull control signal to cause the remotely executing computer instructions 21 to cause the remote computer apparatus 5 to output a respective corresponding full image file.

The GUI 24 has a communication control element in the form of an icon 48 activatable by the pointing device 11, 13 to cause the program 20 to display a menu 49 of preferred contact names and exchange network addresses for enabling selection of at least one contact name from the menu 49. The icon 48 is further activatable to initiate communication between the computer system 2 and a computer system corresponding to the or each selected contact. It will be understood that the program 20 enables its user A to add, delete and amend details of contacts which are to appear in the menu 49. An instant messaging address service, for example AIM or MS Messenger can be used to generate contacts for adding to the menu 49, including information regarding network addresses of computer apparatuses operable to execute the program 21. Alternatively, a dedicated network address brokering service could be used whereby, when an image-sharing event such as a photo-conference starts, users register for the service and are logged on, and their network addresses are registered with the service. The network address details are associated with the contact names in the menu 49, to facilitate one-click operation of the contact function.

When user A desires to share a collection or album of images, s/he executes the 5 program 20. If the desired images are not already stored in the memory of computer system 2, user A arranges to make available to the program 20 image data files relating to the images. For example, a set of holiday photographs could be imported by downloading them to the computer 4 from a capture device such as a digital camera. An import control element 42 activatable by the pointing devices 11, 13 is provided in thee GUI 24 to facilitate this process, and an automatic transfer control element 43 activatable by the pointing devices 11, 13 can also be provided for automatic immediate sharing of downloaded data through the program 20 to other executing programs 21 from the input device 22. This minimises user actions necessary to commence sharing.

The images are displayed as thumbnails 35a-g in the thumbnail display region 34. Scrolling means may be provided if desired for convenient viewing of the thumbnails 35a-g. Also, a means of selecting a desired set of images to appear in the region 34 may be provided for limiting the quantity of thumbnails which are generated by the GUT 24 for use in a particular sharing experience.

To begin an interactive sharing session, user A initiates communication between the computers 4 and 5, for example by selecting a desired user from the menu 49. Many ways of initiating communication will be apparent to the skilled reader. For example, an instant messaging type service can be used to prompt a desired user to execute an image-sharing program 21, or a signal may be sent to the desired user's computer 5 to communicate with an image-sharing program, if running, computer 4 automatically switching to instant messaging or another form of communication if no image-sharing program is responsive. Voice communications are also initiated.

Once the programs 20, 21 are communicating, locally executing program 20 can determine which image files are stored remotely on computer system 3 and label the corresponding thumbnails 35a-g accordingly, using the label “shared”. As seen in FIGS. 2 and 3, five images are presently shared. User A has not elected to share images corresponding to thumbnails 35c and 35f, which are accordingly labelled “Dot shared” “Not shared” image files must be copied to the remote computer system 3 before interactive sharing can start. It will be apparent that the thumbnails 35a-g present the information, which images are available in the set and which are shared, to a user A, B in readily digestible manner.

At the beginning of an interactive sharing session, user B may have none of the image files user A wishes to discuss, or have only some of those files. If user A wishes to transmit a number of image files to user B for sharing, s/he can do this conveniently by selecting a batch of desired thumbnails and activating the send icon 40. If there are several users, several labels 40a-g will be required per thumbnail 35a-g to identify which images are shared with whom.

To initiate discussion of a desired image, user A activates a desired thumbnail 35e with one of the pointing devices 11, 13, causing the corresponding image 31 to be displayed locally in the image display region 9 and remotely as image 50 in the image display region 10. Since the image is shared by concurrently running copies of the corresponding image file, only a control signal is sent to the computer 5 to cause remote processing and display of the remotely stored image. There is thus no requirement to transmit the image 31 as data each time an image is shared, or to transmit data relating to the program 20. Furthermore, the respective resolutions of the images 31 and 50 and the sizes of the windows in which they are displayed can differ without causing display problems.

For carrying out a more detailed discussion of the displayed images 31, 50, the users A and B can synchronously interact with the images using the manipulation control elements, or icons, 36, 37 and 38 in conjunction with voice. Because the images and programs are being executed on respective local computers 4 and 5, only command signals need be communicated between the computers 4 and 5.

This uses much less bandwidth than having to transfer image data and program data each time an image is displayed or manipulated and does not cause problems due to resolution or window size, even if these factors vary between the respective images during the discussion.

An important feature of the programs 20, 21 is that they enable user B to share, display and manipulate images with equal control to user A, although some rules may be necessary for the programs to automatically cope with conflict situations, for example if users A and B initiate commands almost simultaneously.

A private viewing mode control icon 51 is provided so that, if desired, the users can temporarily view and manipulate locally displayed images without interference from other users' control signals and without disturbing other users' viewing.

While the above described programs 24, 25 are similar or identical, it will be understood that his is not essential and that the programs can differ in many ways from one another provided they are interoperable in respect of the features described above.

A computer program is conveniently stored in the form of computer readable instructions, in any suitable form, on a carrier, for putting the embodiment into practice. The carrier may comprise any entity or device capable of caring the program for example a storage medium such as a CD ROM, semi-conductor ROM or other suitable form of ROM, or a magnetic recording medium such as a floppy or hard disk. The carrier might also comprise, for example, a transmissible carrier such as an electrical or optical signal, or an electrical or optical cable, radio or other means for directly conveying such a transmissible carrier, or an integrated circuit in which the carrier is embedded.

It will be apparent that the above described embodiment facilitates intuitive selection and transfer of picture image files for sharing. The embodiment also facilitates synchronous manipulation of picture images by multiple mutually remote users without appreciable delay in sychronisation even at relatively low data transfer rates, such as with a dial-in connection. Furthermore, the embodiment facilitates symmetric user control of picture image manipulation. Still further, the embodiment facilitates synchronous display and manipulation of pictorial images by computer apparatuses independently of respective local display resolutions and/or display window sizes.

The embodiment also facilitates greater dynamic interaction and enjoyment between users synchronously sharing and manipulating images, in that intuitive control of image manipulation and transfer with minimum user input device activity and low response time is facilitated. Furthermore, control is facilitated by any user as desired in contrast to having to be assumed by one user at a time by agreement.

1. Computer apparatus for causing display and manipulation of a pictorial image synchronously with remote computer apparatus, comprising computer instructions executable by the apparatus to generate, on a display screen, a graphical user interface having:
a) an image display region;
b) at least one manipulation control element activatable by a user input device, for manipulating a displayed image; and
c) at least one symbol associated with at least one stored image file, said symbol being activatable by a user input device so as to cause (i) display of a corresponding image in the image display region and (ii) output of a display signal adapted to cause remotely executing computer instructions to process a remotely stored associated image file so as to display a corresponding image.

2. Computer apparatus according to claim 1, operable to determine whether the remotely executing computer instructions can access a remotely stored associated image file for remotely displaying an image and effecting synchronous image manipulation.

3. Computer apparatus according to claim 2, operable to cause a visual indicator, indicative of whether the associated image file is accessible to the remotely executing computer instructions, to be viewable in association with a corresponding said symbol.

4. Computer apparatus according to claim 1, wherein activation of said at least one manipulation control element causes the computer apparatus to (i) generate at least one manipulation control signal for manipulating an image displayed in the display region; and (ii) output a corresponding manipulation control signal adapted to cause synchronous processing by remotely executing computer instructions.

5. Computer apparatus according to claim 1, wherein the graphical user interface has an output control element activatable by a user input device to cause the apparatus to output at least one selected image file for transfer to the remote computer apparatus for processing by the remotely executing computer instructions.

6. Computer apparatus according to claim 1, wherein the or each symbol is activatable by a user input device to cause the computer apparatus to (i) process an associated image file for causing a corresponding image to be displayed in the image display region (ii) determine whether the remotely executing computer instructions can access a remotely stored copy image file for remotely displaying the image and effecting synchronous image manipulation and (iii) if it is determined that said remotely executing computer instructions cannot access a copy image file, output the image file for receipt by the remotely executing computer instructions.

7. Computer apparatus according to claim 1, adapted, on receipt of an image file from remotely executing computer instructions, to cause processing of the image file to cause a corresponding image to be displayed in said image display region.

8. Computer apparatus according to claim 1, adapted to receive at least one manipulation control signal from remotely executing computer instructions for effecting synchronous manipulation of an image displayed in said image display region.

9. Computer apparatus according to claim 1, wherein the graphical user interface has a private viewing mode control element activatable by a user input device to cause the apparatus to temporarily ignore receipt of control signals from and/or suppress output of control signals to the remotely executing computer instructions.

10. Computer apparatus according to claim 1, wherein the graphical user interface has an import control element activatable by a user input device to cause the apparatus to import an image file from an input device.

11. Computer apparatus according to claim 10, wherein the graphical user interface has an automatic transfer control element activatable by a user input device to cause the apparatus to automatically output an imported image file for processing by the remotely executing computer instructions.

12. Computer apparatus according to claim 1, wherein the graphical user interface has a communication control element activatable by a user input device to cause the computer apparatus to initiate communication with least one selected remote computer apparatus.

13. Computer apparatus according to claim 12, wherein the graphical user interface has a select contact control element activatable by a user input device to cause the computer apparatus cause a list of selectable contacts to be displayed.

14. Computer apparatus according to claim 1, further comprising a voice communication system, for simultaneous image data and voice communication.

15. Computer apparatus according to claim 1, wherein the manipulation control element is activatable by a user input device to generate manipulation control signals respectively adapted to cause at least one image manipulation selected from the following: scanning around the image; zooming in and out of chosen aspects of the image; and pointing at chosen aspects of the image with a pointer.

16. Computer apparatus according to claim 1, wherein at least one said symbol is activatable by a pointing device to send a pull control signal to cause the remotely executing computer instructions to cause the remote computer apparatus to output a corresponding image file.

17. Computer apparatus according to claim 1, wherein the graphical user interface has a symbol transfer control element activatable by a user input device to cause the apparatus to output a compressed and low resolution version of an image file corresponding to at least one selected said symbol for enabling the remotely executing computer instructions to cause at least one corresponding symbol to be displayed, the or each corresponding symbol being selectively activatable by a user input device so as to cause the remotely executing computer instructions to output a signal receivable by the computer apparatus for causing it to output a corresponding image file.

18. Apparatus for electronically processing data files, for synchronous manipulation and viewing of shared pictorial images using respective applications programs of mutually substantially similar type loaded on respective remote processing terminals, said apparatus comprising:
a) means for causing a first said applications program to display a plurality of thumbnails respectively selectable by a user input device;
b) means for causing the first said applications program to initiate transmission of at least one selected data file associated with at least one respective selected thumbnail for enabling a second said applications program to display a viewable image using a local copy of the or each data file;
c) means for causing the first said applications program to display a viewable image using an associated said selected data file and;
d) means for causing the first said applications program to display at least one control element adapted to be activated by a user input device to generate a control signal adapted to cause processing of the associated data file to manipulate the displayed viewable image; and
e) means for initiating transmission of a corresponding control signal for causing synchronous processing by at least a second applications program of its local copy of said associated data file to manipulate a corresponding displayed viewable image.

19. An image-sharing system comprising a plurality of computer apparatuses according to claim 1, enabling synchronous display and manipulation of locally stored photographic images with substantially symmetric control by a plurality of computer apparatuses synchronously executing substantially similar respective applications programs.

20. A system according to claim 19, wherein respective said applications programs are operable to cause mutually different respective collections of image files to be stored and to generate respective graphical user interfaces having corresponding mutually different collections of symbols, the collections of image files including common image files shared between executing said applications programs, and non-common image files originating from other sources and not shared between executing said applications programs.

21. A system according to claim 20, wherein symbols corresponding to common image files are displayed with a label identifying them as shared.

22. Computer readable instructions executable by computer apparatus to generate, on a display screen, a graphical user interface having:
d) an image display region;
e) at least one manipulation control element, activatable by a user input device, for manipulating a displayed image; and
f) at least one symbol associated with at least one stored image file, said symbol being activatable by a user input device so as to cause (i) display of a corresponding image in the image display region and (ii) output of a display signal adapted to cause remotely executing computer instructions to process a remotely stored associated image file so as to display a corresponding image.

23. Computer readable instructions according to claim 22, adapted to cause a visual indicator, indicative of whether the associated image file is accessible to the remotely executing computer instructions, to be viewable in association with a corresponding said symbol.

24. Computer readable instructions according to claim 22, adapted (i) to generate an output control element activatable by a user input device to cause computer apparatus to output at least one selected image file for transfer to remote computer apparatus for processing by remotely executing computer instructions, (ii) on receipt of an image file from remotely executing computer instructions, to cause processing of the image file so as to cause a corresponding image to be displayed in said image display region, and (iii) to receive at least one manipulation control signal from remotely executing computer instructions for effecting synchronous manipulation of an image displayed in said image display region.

25. A carrier comprising computer readable instructions according to claim 22.

26. A method for synchronous sharing and manipulation of digital images by respective users having respective computer apparatuses, comprising:
a) causing each respective apparatus to display a graphical user interface comprising (i) at least one symbol activatable for selecting an associated digital image for display and/or transfer and (ii) at least one manipulation control element activatable for manipulating a displayed digital image; and
b) activating a said symbol so as to thereby (i) cause a digital image to be displayed locally and also (ii) when a remote user's computer apparatus has received a copy image file corresponding to the locally displayed digital image, cause a corresponding digital image to be displayed using a remote user's computer apparatus.

27. A method according to claim 26, comprising visually indicating on the graphical user interface whether a digital image file associated with a respective said symbol is accessible by a remote user's computer apparatus.

28. A method according to claim 26, comprising activating a said symbol so as to: (i) cause an associated image to be locally displayed, (ii) determine whether a remote user's computer apparatus can access a corresponding image file, and (iii) if not, automatically send a copy of the image file to the remote user's computer apparatus.

29. A method according to claim 26, comprising activating a said manipulation control element so as to thereby cause respective locally and remotely executing applications programs to process respective local and remote mutually corresponding image files associated with a presently displayed image, for synchronously manipulating said image as displayed locally and remotely.

30. A method according to claim 26, comprising, on receipt of an image file from remote computer apparatus, automatically locally displaying a corresponding image.

31. A method according to claim 26, comprising receiving at least one manipulation control signal from remotely executing computer apparatus and effecting synchronous manipulation of a locally displayed image.

32. A method according to claim 26, comprising viewing digital images in private view mode, so as to temporarily ignore receipt of control signals from and/or suppress output of control signals to the remote computer apparatus.

33. A method according to claim 26, wherein the graphical user interface further comprises a communication control element activatable by a user input device to cause the computer apparatus to initiate communication with least one selected remote computer apparatus.

34. A method according to claim 26, wherein the graphical user interface has a select contact control element activatable by a user input device to cause the computer apparatus cause a list of selectable contacts to be displayed.

35. A method according to claim 26, wherein the graphical user interface has a symbol transfer control element activatable by a user input device to cause the apparatus to transfer a compressed and lower resolution version of at least one selected image file for remote display, without transferring the corresponding higher resolution image file.

36. A method according to claim 26, comprising displaying a menu of contact name icons that are activatable by a user input device so as to cause a computer apparatus to communicate with a remote computer apparatus identified using an activated contact name.

37. A method according to claim 26, comprising using a dedicated network address brokering service to generate a list of network addresses of remote computer apparatuses which are capable of joining together in a photo-conferencing session, and associating said network addresses with a menu of contact names for display in said graphical user interface.

38. A method according to claim 26, comprising using instant messaging services to identify network addresses of remote computer apparatuses which are capable of joining together in a photo-conferencing session, and respectively associating said network addresses with a list of contact names for display in said graphical user interface.

39. Computer apparatus for causing display and manipulation of a pictorial image synchronously with remote computer apparatus, comprising computer instructions executable by the apparatus to generate, on a display screen, a graphical user interface having:
a) an image display region for displaying an image;
b) at least one manipulation control element activatable by a user input device for manipulating a displayed image; and
c) at least one thumbnail associated with at least one stored image file, said thumbnail being activatable by a user input device for displaying an image corresponding to a said stored image file;
said apparatus being operable to determine whether the remotely executing computer instructions can access a remotely stored associated image file for remotely displaying an image and effecting synchronous manipulation of said image, and wherein, if it is so determined that the associated image file is accessible, activation of a said thumbnail causes (i) display of an image in the image display region and (ii) output of a display signal adapted to cause remotely executing computer instructions to process the remotely stored associated image file and display a corresponding image.

40. Computer apparatus according to claim 39, wherein a visual indicator, indicative of whether the associated image file is accessible to the remotely executing computer instructions, is associated with the or each symbol.

41. A method for synchronous collaborative viewing of a collection of photographic pictures, comprising:
a) running a first applications program to cause a plurality of symbols to be displayed corresponding to a plurality of stored picture files;
b) in response to receipt of a control signal, initiating transfer of selected said picture files to enable processing thereof by a second applications program of similar type to said first applications program; and
c) causing to be displayed a visual indication for distinguishing symbols corresponding to transmitted picture files.

42. Computer apparatus comprising computer instructions executable by the apparatus to generate, on a display screen, a graphical user interface having:
a) an image display region for displaying an image;
b) at least one symbol activatable by a user input device for selecting at least one respective associated image file;
c) an output control element activatable by a user input device to cause the apparatus to output at least one selected image file for processing by the remotely executing computer instructions; and
d) a symbol transfer control element activatable by a user input device to cause the apparatus to output a compressed and low resolution version of at least one selected image file for enabling substantially similar, remotely executing, computer instructions to cause at least one corresponding symbol to be displayed.

43. Computer apparatus for causing display and manipulation of a pictorial image synchronously with remote computer apparatus, comprising computer instructions executable by the apparatus to generate, on a display screen, a graphical user interface having:
a) an image display region for displaying an image;
b) at least one symbol activatable by a user input device for selecting at least one respective associated image file; and
c) at least one manipulation control element activatable by a user input device to:
i) generate at least one manipulation control signal for manipulating an image displayed in the display region; and
ii) cause the apparatus to output a corresponding manipulation control signal adapted to cause synchronous processing by substantially similar, remotely executing, computer instructions.
